(19) United States
(12) Patent Application Publication
(10) Pub. No.: US 2026/0233799 A1
(43) Pub. Date: Aug. 13, 2026

(54) PEDAL-EQUIPPED BICYCLE

(71) Applicant: YAMAHA HATSUDOKI KABUSHIKI KAISHA, Iwata-shi (JP)

(72) Inventors: Tomoyuki HIGASHI, Shizuoka (JP); Mitsuharu HASUMI, Shizuoka (JP); Nobuo HARA, Shizuoka (JP)

(21) Appl. No.: 19/639,355

(22) Filed: Apr. 6, 2026

Related U.S. Application Data
(63) Continuation-in-part of application No. PCT/JP2024/035790, filed on Oct. 7, 2024.

(30) Foreign Application Priority Data
Oct. 6, 2023 (WO) PCT/JP2023/036643

(51) Int. Cl. B62K 21/00; B62J 43/30; B62J 45/411

(52) U.S. Cl. CPC B62K 21/00; B62J 43/30; B62J 45/411

(57) ABSTRACT

A pedal-equipped bicycle includes a vehicle body frame including a head tube and a down tube, a front fork, and a steering assist device including a battery, a steering assist motor, a torque transmission, and a first power source harness. The steering assist device is located farther forward than a midpoint of a line segment connecting a front wheel axle and a rear wheel axle of the pedal-equipped bicycle and a rotation center of a left crank and a right crank as viewed in a left-right direction, and the battery and the steering assist motor are located so as to at least partially overlap the down tube as viewed in an up-down direction.

### CROSS REFERENCE TO RELATED APPLICATIONS

This application claims the benefit of priority to PCT Application No. PCT/JP2023/036643 filed on Oct. 6, 2023 and is a Continuation-in-Part Application of PCT Application No. PCT/JP2024/035790 filed on Oct. 7, 2024. The entire contents of each application are hereby incorporated herein by reference.

### BACKGROUND OF THE INVENTION

### 1. Field of the Invention

The present invention relates to pedal-equipped bicycles.

### 2. Description of the Related Art

Pedal-equipped bicycles that include an electric-power-steering system (EPS) that assists handling of a rider via an electric actuator are known. The electric power steering system includes a steering assist device that transmits a torque to a steering column of the pedal-equipped bicycle via an electric steering assist motor, various sensors that detect a steering torque applied to the steering column, a steering angle velocity, or the like, and a control device that controls the steering assist motor. The control device controls the steering assist motor based on detection values of the various sensors.

The steering assist motor is arranged on the pedal-equipped bicycle in a state where the steering assist motor is mechanically connected to the steering column via a gear or the like. An electric assist bicycle for the pedal-equipped bicycle described in International Patent Publication No. WO 2017/057515 includes a steering auxiliary device that applies an auxiliary force to a steering column, an assist motor that applies an auxiliary force to a rear wheel, a battery that supplies electric power to the steering auxiliary device and the assist motor, a first power source harness member that electrically connects the steering auxiliary device and the battery, and a second power source harness member that electrically connects the assist motor and the battery.

A pedal-equipped bicycle is configured to transmit a rotational force to a rear wheel that is a drive wheel by alternately pedaling on a left pedal and a right pedal arranged at left and right sides of a vehicle body frame, respectively. In the pedal-equipped bicycle, for example, when the rider pedals on the left pedal, a downward force is applied at a farther left side than a virtual centerline in a left-right direction of a vehicle that is not leaning in a left direction or in a right direction (hereinafter referred to as a “virtual centerline”), as viewed from a front-rear direction. Thus, a center of gravity of the pedal-equipped bicycle including the rider shifts to a left side from the virtual centerline.

At this time, the rider pulls up a left handlebar with the left hand in order to receive an upward reaction force generated by pedaling down on the left pedal and maintain a traveling direction of the vehicle. The pedal-equipped bicycle leans rightward due to pulling of the left handlebar upward by the rider. Thus, a combined center of gravity of the pedal-equipped bicycle including the rider that had moved farther leftward than the virtual centerline due to pedaling on the left pedal moves toward the virtual centerline.

Next, when the rider moves the left pedal to a lowest position, the rider stops pulling up the left handlebar, then pedals on the right pedal, and pulls up a right handlebar. The vehicle that was leaning rightward returns from a right-leaning posture to a posture not leaning either leftward or rightward (hereinafter referred to as a “neutral posture”) due to pulling up of the right handlebar by the rider. When the vehicle returns to the neutral posture, the rider starts pedaling on the right pedal in a same manner as pedaling on the left pedal.

On the pedal-equipped bicycle, when pedaling on the left and right pedals with a larger pedaling force, the rider performs “dancing” that is an operation of pedaling on the left and right pedals in a state where the rider stands up from a saddle. Leaning of the pedal-equipped bicycle during dancing increases to be larger than leaning of the pedal-equipped bicycle when the rider pedals on the left and right pedals in a state where the rider does not sit on the saddle. Thus, the rider maintains balance and a traveling direction of the pedal-equipped bicycle by causing the pedal-equipped bicycle to lean leftward or rightward based on a level of pedaling on the left and right pedals. Therefore, in the pedal-equipped bicycle, the more uniform a left-right weight balance is, the better operability during dancing is increased.

Furthermore, the steering auxiliary device assists steering by transmitting a torque from a drive device, such as a motor or the like, to the steering column that supports a front wheel. Torque transmission of the steering auxiliary device depends on a friction force between the front wheel and a road surface. In other words, in order to transmit the torque of the steering auxiliary device, it is necessary to take a load on the front wheel into consideration.

The battery and the second power source harness member of the steering auxiliary device in the electric assist bicycle described in International Patent Publication No. WO 2017/057515 described above are arranged at rear of a seat post. In the electric assist bicycle, a weight of the battery and the second power source harness member is applied more to a rear wheel axle than to a front wheel axle. In the electric assist bicycle, the load on the front wheel tends to be smaller than the load on the rear wheel. That is, in the electric assist bicycle, friction generated between the front wheel and the road surface tends to be smaller than friction generated between the rear wheel and the road surface.

Furthermore, in the electric assist bicycle described in International Patent Publication No. WO 2017/057515 described above, a motor provided for the steering auxiliary device is arranged in front of a head tube. Therefore, a moment of inertia about a yaw axis is increased in the electric assist bicycle. Accordingly, in the electric assist bicycle, the larger the moment of inertia about the yaw axis is, the more difficult it is to achieve an effect of the steering auxiliary device.

Therefore, a pedal-equipped bicycle that increases responsiveness and control accuracy of the steering assist device while reducing or preventing a deterioration in operability during dancing is desired.

### SUMMARY OF THE INVENTION

Example embodiments of the present provide pedal-equipped bicycles including steering assist devices mounted thereon that increase responsiveness and control accuracy of the steering assist devices while reducing or preventing deterioration in operability during dancing.

The inventors of example embodiments of the present invention studied pedal-equipped bicycles that, even when a steering assist device is mounted thereon, increase responsiveness and control accuracy of the steering assist device while reducing or preventing deterioration in operability during dancing. As a result of intensive studies, the inventors arrived at the following configurations. A technical concept thereof is to increase a front wheel load by consolidating a steering assist motor, a battery, a first power source harness, and a torque transmission of a steering assist device that is a heavy load, thus increasing responsiveness and control accuracy of the steering assist device while reducing or preventing the deterioration in operability during dancing.

According to an example embodiment of the present invention, a pedal-equipped bicycle includes a vehicle body frame including a head tube and a down tube including a front end connected to a rear edge of the head tube and obliquely extending such that a rear end portion of the down tube is located lower than the front end, a front wheel supported by a front fork including a steering column rotatably supported by the head tube, a rear wheel supported by the vehicle body frame, a left crank and a right crank supported by the vehicle body frame, and a steering assist device including a steering assist motor, a battery to supply electric power to the steering assist motor, a first power source harness to electrically connect the steering assist motor and the battery, and a torque transmission to transmit a torque of the steering assist motor to the steering column.

The steering assist motor, the battery, the first power source harness, and the torque transmission (1) are located farther forward than a midpoint of a line segment connecting axles of the front wheel and the rear wheel of the pedal-equipped bicycle and farther forward than a rotation center of the left crank and the right crank as viewed in a left-right direction of the pedal-equipped bicycle, and (2) at least partially overlap the down tube as viewed in an up-down direction of the pedal-equipped bicycle.

As described above, the steering assist motor, the battery, the first power source harness, and the torque transmission are (1) located farther forward than the midpoint of the line segment connecting the axles of the front wheel and the rear wheel of the pedal-equipped bicycle and farther forward than the rotation center of the left crank and the right crank as viewed in the left-right direction. Therefore, the steering assist motor, the battery, the first power source harness, and the torque transmission are not located farther rearward than the midpoint of the line segment connecting the axles of the front wheel and the rear wheel and the rotation center of the left crank and the right crank.

Furthermore, the steering assist motor, the battery, the first power source harness, and the torque transmission (2) at least partially overlap the down tube as viewed in the up-down direction. Therefore, the steering assist motor, the battery, the first power source harness, and the torque transmission are not located farther forward than the head tube. Even when one or more of the steering assist motor, the battery, the first power source harness, and the torque transmission include a portion located farther forward than the head tube, the steering assist motor, the battery, the first power source harness, and the torque transmission at least partially overlap the down tube, and therefore, an amount of protrusion toward the head tube can be reduced or prevented.

Components of the steering assist device, including the steering assist motor, the battery, the first power source harness, and the torque transmission are consolidated farther rearward than the head tube and farther forward than the midpoint of the line segment connecting a front wheel axle of the front wheel and a rear wheel axle of the rear wheel and the rotation center of the left crank and the right crank. Therefore, in the pedal-equipped bicycle, a ratio of a weight applied to the front wheel axle to a weight of the steering assist device is larger than a ratio of a weight applied to the front wheel axle to a weight of a steering assist device of the electric assist bicycle described in International Patent Publication No. WO 2017/057515 in which components of the steering assist device are dispersedly arranged. That is, in the pedal-equipped bicycle, a ratio of a friction force generated between the front wheel and a road surface out of a total friction force generated between the front wheel and the rear wheel and the road surface due to the weight of the steering assist device is larger than a ratio of a friction force generated between the front wheel and the road surface out of a total friction force generated between the front wheel and the rear wheel and the road surface due to the weight of the steering assist device in the electric assist bicycle described in International Patent Publication No. WO 2017/057515. Therefore, the friction force generated between the front wheel and the road surface increases by using the weight of the steering assist device. Thus, the torque of the steering assist motor is transmitted more directly to the road surface so that control accuracy of the steering assist device is increased.

Furthermore, even when a load applied to the front wheel increases and the components of the steering assist device including the steering assist motor, the battery, the first power source harness, and the torque transmission are located farther rearward than the head tube or one or some of the components have a portion located farther forward than the head tube, the amount of protrusion is reduced or prevented so that an increase in a moment of inertia about a yaw axis of the pedal-equipped bicycle is reduced or prevented. Thus, the responsiveness of a turning control of the steering assist device can be increased while increasing a friction force generated at the front wheel.

In addition, an offset amount of the steering assist device relative to a virtual center plane extending through a centerline of the pedal-equipped bicycle in the left-right direction is reduced or prevented. That is, a weight balance between left and right sides of the pedal-equipped bicycle is less likely to be biased. Thus, an influence of the steering assist device on an operation (dancing) causing the pedal-equipped bicycle to lean leftward or rightward can be reduced or prevented while increasing a degree of freedom of movement of the legs of a rider positioned at both left and right of the steering assist device. Based on the foregoing, by consolidating the steering assist motor, the battery, the first power source harness, and the torque transmission to increase the front wheel load, the responsiveness and control accuracy of the steering assist device can be increased while reducing or preventing deterioration in operability during dancing.

According to another example embodiment, the pedal-equipped bicycle of the present invention may have the following configuration. The steering assist motor, the battery, the first power source harness, and the torque transmission are located between a right outer edge of a left pedal supported by the left crank and a left outer edge of a right pedal supported by the right crank as viewed in the up-down direction.

As described above, the steering assist motor, the battery, the first power source harness, and the torque transmission are located between a pair of virtual planes through which the right outer edge of the left pedal and the left outer edge of the right pedal extend. That is, interference of the steering assist motor, the battery, the first power source harness, and the torque transmission with the left leg of the rider located farther leftward than the right outer edge of the left pedal and the right leg of the rider located farther rightward than the left outer edge of the right pedal is reduced or prevented. Therefore, in the pedal-equipped bicycle including the steering assist device, there is an increase in the freedom of movement of the legs of the rider. Furthermore, the steering assist motor, the battery, the first power source harness, and the torque transmission are located so as to at least partially overlap the down tube, as viewed in the up-down direction, so that the weight balance in the left-right direction is less likely to be biased. Thus, deterioration in the operability during leaning in the left direction or the right direction in accordance with pedaling on the left pedal and the right pedal by the rider can be reduced or prevented.

According to another example embodiment, the pedal-equipped bicycle may have the following configuration. The steering assist motor, the battery, the first power source harness, and the torque transmission are located between both ends of a crank shaft that connects the left crank and the right crank, as viewed in the up-down direction.

As described above, the steering assist motor, the battery, the first power source harness, and the torque transmission are located between a pair of virtual planes each extending through a corresponding one of both ends of the crank shaft. That is, the steering assist motor, the battery, the first power source harness, and the torque transmission are spaced apart from the left leg of the rider located farther leftward than the right outer edge of the left pedal and the right leg of the rider located farther rightward than the left outer edge of the right pedal toward the down tube. Therefore, in the pedal-equipped bicycle including the steering assist device, there is an increase in the freedom of movement of the legs of the rider. Thus, deterioration in the operability during leaning in the left direction or the right direction in accordance with pedaling on the left pedal and the right pedal by the rider can be reduced or prevented.

According to another example embodiment, the pedal-equipped bicycle may have the following configuration. The steering assist motor, the battery, the first power source harness, and the torque transmission are located between a left outer edge and a right outer edge of the down tube, as viewing the pedal-equipped bicycle in the up-down direction.

As described above, the steering assist motor, the battery, the first power source harness, and the torque transmission are located between a pair of virtual planes each passing through a corresponding one of the left outer edge and the right outer edge of the down tube. Accordingly, the steering assist motor, the battery, the first power source harness, and the torque transmission are located close to an axis of the down tube within a width of the down tube in the left-right direction. Therefore, in the pedal-equipped bicycle including the steering assist device, the freedom of movement of the legs of the rider is increased. Furthermore, a deviation of the weight balance of the pedal-equipped bicycle in the left-right direction caused by locating the steering assist motor, the battery, the first power source harness, and the torque transmission is reduced or prevented. Thus, deterioration in operability during leaning in the left-right direction by the rider in accordance with pedaling on the left pedal and the right pedal can be reduced or prevented.

According to another example embodiment, the pedal-equipped bicycle may have the following configuration. The steering assist motor, the battery, the first power source harness, and the torque transmission are located between a left outer edge of a left fork of the front fork and a right outer edge of a right fork of the front fork as viewed in the up-down direction.

As described above, the steering assist motor, the battery, the first power source harness, and the torque transmission are located between a pair of virtual planes each extending through a corresponding one of the left outer edge and the right outer edge of the front fork. That is, the steering assist motor, the battery, the first power source harness, and the torque transmission are not located more outward than the front fork in the left-right direction as viewed in the front-rear direction. Therefore, while reducing or preventing contact of the steering assist motor, the battery, the first power source harness, and the torque transmission with an obstacle or the like approaching from a front of the pedal-equipped bicycle, a deviation of the weight balance of the pedal-equipped bicycle in the left-right direction caused by the location of the steering assist motor, the battery, the first power source harness, and the torque transmission. Thus, deterioration in operability during leaning in the left-right direction by the rider in accordance with pedaling on the left pedal and the right pedal can be reduced or prevented.

The terminology used herein is for the purpose of describing particular example embodiments only and is not intended to be limiting of the present invention.

As used herein, the term “and/or” includes any and all combinations of one or more of the associated listed items.

It will be further understood that the terms “including,” “comprising” or “having” and variations thereof when used in this specification specify the presence of stated features, pedals, operations, elements, components, and/or their equivalents, but do not preclude the presence or addition of one or more pedals, operations, elements, components, and/or groups thereof.

It will be further understood that the terms “mounted,” “connected,” “coupled,” and/or their equivalents thereof are used broadly and encompass both “direct and indirect” mounting, connecting, and coupling. Furthermore, “connected” and “coupled” are not restricted to physical or mechanical connections or couplings, and can include electrical connections or couplings whether direct or indirect.

Unless otherwise defined, all terms (including technical and scientific terms) used herein have the same meaning as commonly understood by one having ordinary skill in the art.

It will be further understood that terms, such as those defined in commonly used dictionaries, should be interpreted as having a meaning that is consistent with their meaning in the context of the relevant art and the present invention and will not be interpreted in an idealized or overly formal sense unless expressly so defined herein.

In describing herein, it will be understood that a number of techniques and pedals are disclosed. Each of these has individual benefit and each can also be used in conjunction with one or more, or in some cases all, other features.

Accordingly, for the sake of clarity, this description will refrain from repeating every possible combination of the individual pedals in an unnecessary manner. Nevertheless, the specification and claims should be read with the understanding that such combinations are entirely within the scope of the present invention.

In this specification, example embodiments of a pedal-equipped bicycle according to the present invention will be described.

In the following description, for purposes of explanation, numerous specific details are set forth in order to provide a thorough understanding of the present invention. It will be evident, however, to one skilled in the art that the present invention can be practiced without these specific details.

Therefore, the following disclosure is to be considered as an exemplification of the present invention, and is not intended to limit the present invention to the specific example embodiments illustrated by the figures or description below.

In this specification, the term “pedal-equipped bicycle” refers to a leaning vehicle configured such that a vehicle body frame is supported by one front wheel located in front of the vehicle body frame and one rear wheel that is a drive wheel located at a rear of the vehicle body frame. Furthermore, the pedal-equipped bicycle includes a left pedal and a right pedal used by a rider to transmit a torque to the drive wheel. The pedal-equipped bicycle is configured to transmit a torque, to the drive wheel, generated by alternately pedaling on the left pedal located at the left of the vehicle body frame and the right pedal located at the right of the vehicle body frame by the rider. In the pedal-equipped bicycle, the front wheel is rotatably supported, for example, by a Matsuba-type fork rotatably supported by the vehicle frame.

In this specification, the term “head tube” refers to a portion that supports a front fork in a vehicle body frame of the pedal-equipped bicycle. The head tube is located at a front end portion of the vehicle body frame. The head tube is a pipe-shaped member made of a material, such as iron, aluminum, carbon, or the like. A top tube that extends rearward and a down tube that extends rearward and downward are connected to a rear end portion of the head tube. That is, the head tube connects the top tube and the down tube.

In this specification, the term “down tube” refers to a portion that connects the head tube that supports the front fork and a bottom bracket hanger that supports rotation axes of the left pedal and the right pedal in the vehicle body frame of the pedal-equipped bicycle. The down tube is a pipe-shaped member made of a material, such as iron, aluminum, carbon, or the like. The down tube extends rearward and downward from the head tube. Therefore, the down tube obliquely extends such that an upper end portion thereof is located farther rearward than a lower end portion thereof.

In this specification, the term “steering column” refers to an element that is rotatably housed in the head tube and is connected to a fork portion that rotatably supports the front wheel in the pedal-equipped bicycle. A steering column connection portion of a bicycle stem is connected to the steering column.

In this specification, the term “steering assist device” refers to a device configured by combining an electric steering assist motor of an electric steering, a torque transmission that transmits a torque of the steering assist motor to the steering column, a battery that supplies electric power to the steering assist motor, and a first power source harness that electrically connects the steering assist motor and the battery. The steering assist motor transmits a torque to the torque transmission based on input of a force from a rider or a road surface. The torque transmission amplifies the torque of the steering assist motor and transmits the torque to the steering column that is a torque transmission target. The steering assist device performs, for example, support for steering of a two-wheeled vehicle by the rider, a steering operation to cause a vehicle body to stand upright by itself, or the like. Note that the steering assist device may also include, in addition to the steering assist motor, the torque transmission, the battery, and the first power source harness, for example, a controller, an input device, an output device, or the like.

In this specification, the term “first power source harness” refers only to a portion that electrically connects the battery and the steering assist motor in an entire harness of the pedal-equipped bicycle. In a pedal-equipped bicycle including a drive motor that provides an auxiliary driving force to a rear wheel or a front wheel, a portion that electrically connects the drive motor and the battery is referred to as a second power source harness and is not included in the first power source harness. Furthermore, a signal line that transmits a control signal from an input device of the steering assist device to a controller or the like and a signal line that transmits a detection signal of a torque sensor to the controller or the like are not included in the first power source harness.

In this specification, the term “front-rear direction” refers to a front-rear direction, as viewed from the rider operating the pedal-equipped bicycle, in a state where the steering assist device is mounted on the pedal-equipped bicycle.

In this specification, the term “left-right direction” refers to a left-right direction, as viewed from the rider operating the pedal-equipped bicycle, in a state where the steering assist device is mounted on the pedal-equipped bicycle.

In this specification, the term “up-down direction” refers to an up-down direction, as viewed from the rider operating the pedal-equipped bicycle, in a state where the steering assist device is mounted on the pedal-equipped bicycle.

In this specification, the term “torque transmission” refers to a mechanism that transmits a torque input via an input member to an output member. The torque transmission may be configured to change the magnitude, direction, and the like of the input torque and transmit the input torque. Examples of the torque transmission include a gear, a chain, a belt, or a link.

In this specification, the term “dancing” refers to one method of riding the pedal-equipped bicycle. During the dancing, the rider of the pedal-equipped bicycle causes a vehicle body to alternately lean leftward and rightward in accordance with pedaling on the left pedal and the right pedal while alternately pedaling on the left pedal and the right pedal in a state where the rider does not sit on a saddle. Dancing is used when transmitting a large torque to the pedal-equipped bicycle when traveling on a climbing road, when accelerating, or the like. Note that dancing includes a case where the rider causes the vehicle body to alternately lean leftward and rightward in accordance with pedaling on the left pedal and the right pedal in a state where the rider sits on the saddle.

In this specification, the term “yaw axis of the pedal-equipped bicycle” refers to an axis extending in the up-down direction and extending through a center of gravity of the pedal-equipped bicycle. The yaw axis of the pedal-equipped bicycle in a state where the rider is riding on the pedal-equipped bicycle is an axis extending in the up-down direction and extending through a combined center of gravity of a center of gravity of the rider and the center of gravity of the pedal-equipped bicycle.

In this specification, the term “left outer edge as viewed in the up-down direction” refers to a boundary of a portion located leftmost as viewed in the up-down direction. The term “right outer edge as viewed in the up-down direction” refers to a boundary of a portion located rightmost as viewed in the up-down direction.

According to example embodiments of the present invention, the responsiveness and control accuracy of a steering assist device are increased while reducing or preventing deterioration in operability during dancing.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of a pedal-equipped bicycle according to a first example embodiment of the present invention.

FIG. 2 is a top view of the pedal-equipped bicycle according to the first example embodiment of the present invention.

FIG. 3 is a view taken along the arrow III-III in FIG. 1.

FIG. 4 is a view taken along the arrow IV-IV in FIG. 1.

FIG. 5 is a front view of the pedal-equipped bicycle according to the first example embodiment of the present invention in a state where a left pedal and a right petal of the pedal-equipped bicycle are not pedaled on by a rider.

FIG. 6 is a front view of the pedal-equipped bicycle according to the first example embodiment of the present invention in a state where the pedal-equipped bicycle is caused to lean rightward when the left pedal of the pedal-equipped bicycle is pedaled on by the rider.

FIG. 7 is a front view of the pedal-equipped bicycle according to the first example embodiment of the present invention in a state where the pedal-equipped bicycle is caused to lean leftward when the right pedal of the pedal-equipped bicycle is pedaled on by the rider.

FIG. 8 is a side view of a pedal-equipped bicycle according to a variation of the first example embodiment of the present invention.

### DETAILED DESCRIPTION OF THE EXAMPLE EMBODIMENTS

Example embodiments of the present invention will be described hereinafter with reference to the drawings. In the drawings, the same or corresponding parts are denoted by the same reference characters, and description thereof will not be repeated. The dimensions of components in the drawings do not strictly represent actual dimensions of the components and dimensional proportions of the components, for example.

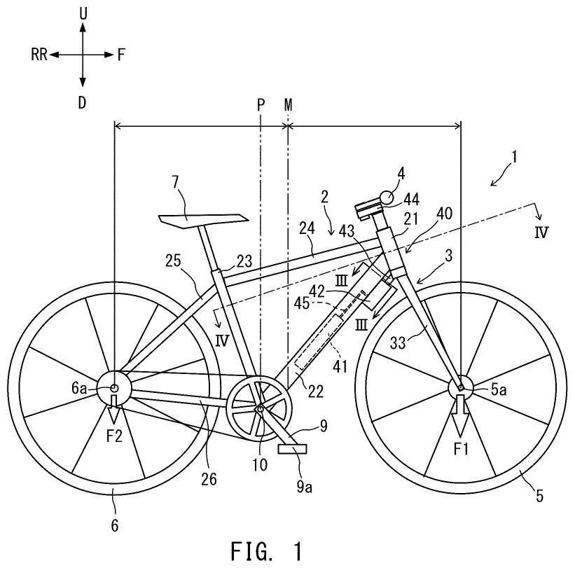

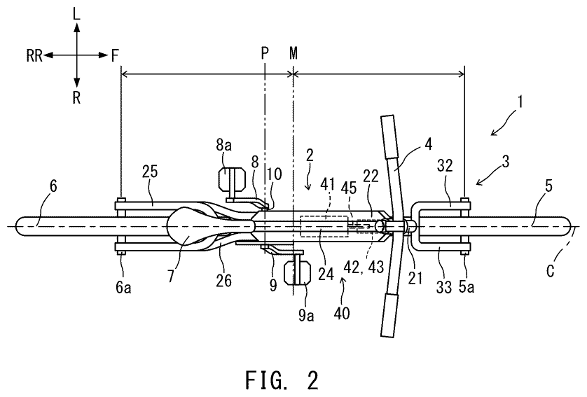

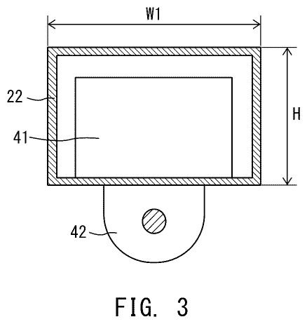

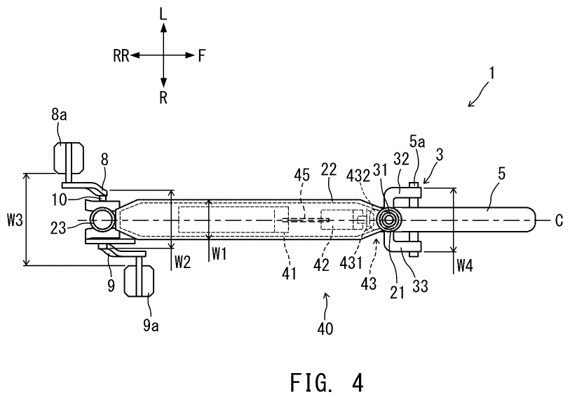

A pedal-equipped bicycle 1 according to a first example embodiment of the present invention will be described with reference to FIG. 1 to FIG. 4. FIG. 1 is a side view of the pedal-equipped bicycle 1 according to a first example embodiment of the present invention. FIG. 2 is a top view of the pedal-equipped bicycle 1 according to the first example embodiment of the present invention. FIG. 3 is a view taken along the arrow III-III in FIG. 1. FIG. 4 is a view taken along the arrow IV-IV in FIG. 1.

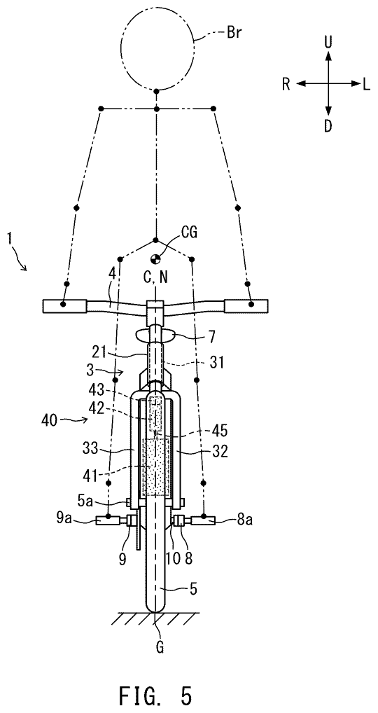

In the following description, an arrow F in the drawings represents a forward direction of the pedal-equipped bicycle 1. An arrow RR in the drawings represents a rearward direction of the pedal-equipped bicycle 1. An arrow U in the drawings represents an upward direction of the pedal-equipped bicycle 1. An arrow D in the drawings represents a downward direction of the pedal-equipped bicycle 1. An arrow L in the drawings represents a leftward direction of the pedal-equipped bicycle 1. An arrow R in the drawings represents a rightward direction of the pedal-equipped bicycle 1. In the following description, an up-down direction, a left-right direction, and a front-rear direction refer to an up-down direction, a left-right direction, and a front-rear direction, respectively, as viewed from a rider Br (see FIG. 5) operating the pedal-equipped bicycle 1.

As illustrated in FIG. 1 and FIG. 2, the pedal-equipped bicycle 1 according to this example embodiment includes a steering assist device 40. The pedal-equipped bicycle 1 includes a vehicle body frame 2, a front fork 3, a handlebar 4, a front wheel 5, a rear wheel 6, a saddle 7, a left crank 8, a right crank 9, and a crank shaft 10. Configurations of the handlebar 4, the front wheel 5, the rear wheel 6, the saddle 7, the left crank 8, and the right crank 9 are similar to those of a known bicycle, and therefore, detailed description thereof will be omitted. Components similar to those of the first example embodiment are denoted by the same reference characters and description thereof will be omitted.

The vehicle body frame 2 supports the front fork 3, the rear wheel 6, the saddle 7, the left crank 8, and the right crank 9. The vehicle body frame 2 includes a head tube 21, a down tube 22, a seat tube 23, a top tube 24, a seat stay 25, and a chain stay 26.

The head tube 21 supports the front fork 3. The head tube 21 is located in a front end portion of the vehicle body frame 2. The head tube 21 extends in the up-down direction.

The down tube 22 connects the head tube 21 and the seat tube 23. The down tube 22 extends rearward and downward from a rear edge of the head tube 21. A rear end portion of the head tube 21 is located lower than a front end portion thereof. A front end portion of the down tube 22 is connected to a lower end portion of the head tube 21. A rear end portion of the down tube 22 is connected to a lower end portion of the seat tube 23.

As illustrated in FIG. 3, as viewed in an axial direction, a width W1 of the down tube 22 in the left-right direction is larger than a width H of the down tube 22 in a direction perpendicular to the axial direction and the left-right direction. That is, a cross section of the down tube 22 perpendicular to the axis of the down tube 22 has a rectangular shape extending in the left-right direction.

As illustrated in FIG. 1, the seat tube 23 connects the down tube 22 and the top tube 24. The seat tube 23 supports the saddle 7.

The top tube 24 connects the seat tube 23 and the head tube 21. The top tube 24 extends forward and upward from a front edge of an upper end portion of the seat tube 23. A front end portion of the top tube 24 is located higher than a rear end portion thereof. A rear end portion of the top tube 24 is connected to the upper end portion of the seat tube 23. The front end portion of the top tube 24 is connected to an upper end portion of the head tube 21.

The seat stay 25 and the chain stay 26 support the rear wheel 6. Front end portions of the seat stay 25 and the chain stay 26 extend rearward from the seat tube 23. Rear end portions of the seat stay 25 and the chain stay 26 are connected to each other. The rear end portion of the chain stay 26 is connected to the rear end portion of the seat stay 25.

The vehicle body frame 2 configured as described above rotatably supports the front fork 3 via the head tube 21. The vehicle body frame 2 supports the saddle 7 via the seat tube 23. The vehicle body frame 2 rotatably supports the crank shaft 10 via a connection portion of the down tube 22 and the seat tube 23. Furthermore, the vehicle body frame 2 supports a rear wheel axle 6a of the rear wheel 6 via a connection portion of the seat stay 25 and the chain stay 26.

The front fork 3 supports the front wheel 5. The front fork 3 includes a steering column 31, a left fork portion 32, and a right fork portion 33. The front fork 3 is configured as a Matsuba-type fork. A lower end portion of the steering column 31 is connected to upper end portions of the left fork portion 32 and the right fork portion 33. The steering column 31 extends through the head tube 21. Furthermore, the steering column 31 is rotatably supported by the head tube 21. The left fork portion 32 and the right fork portion 33 support a front wheel axle 5a of the front wheel 5. The handlebar 4 is mounted on an upper end portion of the steering column 31 via a stem 4a.

As illustrated in FIG. 4, the crank shaft 10 supports the left crank 8 and the right crank 9. The crank shaft 10 extends in the left-right direction of the vehicle body frame 2. Each of both end portions of the crank shaft 10 protrudes in the left-right direction of the vehicle body frame 2 in order to support a corresponding one of the left crank 8 and the right crank 9. That is, as viewed in the up-down direction, a distance W2 between both ends of the crank shaft 10 with a virtual center plane C centered therebetween is longer than the width W1 of the down tube 22 in the left-right direction with the virtual center plane C centered therebetween.

The left crank 8 and the right crank 9 convert a pedaling force of the rider Br to a rotational force. One end portion of the left crank 8 is connected to a left end portion of the crank shaft 10. One end portion of the right crank 9 is connected to a right end portion of the crank shaft 10. The other end portion of the left crank 8 is located farther leftward than the one end portion thereof. A left pedal 8a is rotatably supported on the other end of the left crank 8. The left pedal 8a is positioned to the left of the left crank 8. The other end portion of the right crank 9 is located farther rightward than the one end portion thereof. A right pedal 9a is rotatably supported on the other end portion of the right crank 9. The right pedal 9a is positioned to the right of the right crank 9. Therefore, as viewed in the up-down direction, a distance W3 between a right outer edge of the left pedal 8a and a left outer edge of the right pedal 9a with the virtual center plane C centered therebetween is larger than the width W1 of the down tube 22 in the left-right direction with the virtual center plane C centered therebetween and the distance W2 between the both end portions of the crank shaft 10.

Furthermore, as viewed in the up-down direction, the distance W3 between the right outer edge of the left pedal 8a and the left outer edge of the right pedal 9a with the virtual center plane C centered therebetween is larger than a distance W4 between a left outer edge of the left fork portion 32 and a right outer edge of the right fork portion 33 with the virtual center plane C centered therebetween. That is, as viewed in the up-down direction, the distance W4 between the left outer edge of the left fork portion 32 and the right outer edge of the right fork portion 33 is larger than the width W1 of the down tube 22 in the left-right direction and the distance W2 between the both ends of the crank shaft 10.

As illustrated in FIG. 1 to FIG. 4, the steering assist device 40 is a drive device of an electric power steering that assists a handlebar operation of the pedal-equipped bicycle 1. The steering assist device 40 is supported by the down tube 22. The steering assist device 40 controls a torque of the steering column 3 based on a detection value of a torque sensor 44 that detects the torque applied to the steering column 31.

The steering assist device 40 includes a battery 41, a steering assist motor 42, a torque transmission 43, the torque sensor 44, and a first power source harness 45.

The battery 41 is a power source of the steering assist motor 42. The battery 41 is configured using a known storage battery, such as a lithium-ion battery or the like. The battery 41 is electrically connected to the steering assist motor 42 and the torque sensor 44. In this example embodiment, the battery 41 is supported by the down tube 22. Furthermore, at least a portion of the battery 41 is housed inside the down tube 22.

The closer the battery 41 is located to a lower end portion of the down tube 22, the closer the battery 41 becomes to the road surface where the front wheel 5 and the rear wheel 6 are in contact. A moment of inertia about a rotation center of the pedal-equipped bicycle 1 when the pedal-equipped bicycle 1 is caused to lean in the left-right direction with a grounding position G (see FIG. 5) of the front wheel 5 and the rear wheel 6 as the rotation center decreases as the center of gravity of the pedal-equipped bicycle 1 approaches the rotation center. The smaller the moment of inertia around the rotation center is, the easier it is to cause the pedal-equipped bicycle 1 to lean in the left-right direction.

The steering assist motor 42 outputs a torque to the steering column 31. The steering assist motor 42 is an electric motor that operates with electric power from the battery 41. In this example embodiment, the steering assist motor 42 is supported by a lower surface of the down tube 22.

The torque transmission 43 changes (increases or decreases) the torque output by the steering assist motor 42 and transmits the torque to the steering column 1. The torque transmission 43 is connected to the steering assist motor 42 and the steering column 31. Note that a configuration of the torque transmission 43 may be any configuration, for example, a gear, a link, a belt, a chain, or the like, as long as the torque transmission 43 can transmit the torque from the steering assist motor 42 to the steering column 31.

As illustrated in FIG. 4, the torque transmission 43 includes an input gear 431 fixed to an output shaft of the steering assist motor 42 and an output gear 432 fixed to the steering column 31. The input gear 431 is configured as a bevel gear. The output gear 432 is configured as, for example, a fan-shaped bevel gear. A diameter of the output gear 432 is larger than a diameter of the input gear 431. Therefore, the torque transmission 43 increases the torque output by the steering assist motor 42 and transmits the torque to the steering column 31. In this example embodiment, the torque transmission 43 is supported by the lower surface of the down tube 22.

The torque sensor 44 detects the torque applied to the steering column 31. The torque sensor 44 is provided on the stem 4a that supports the handlebar 4. The torque sensor 44 includes, for example, a strain gauge that detects strain around a rotation axis of the steering column 31. The torque sensor 44 transmits a torque detection signal to an unillustrated controller of the steering assist device 40.

The first power source harness 45 electrically connects the battery 41 and the steering assist motor 42. The first power source harness 45 supplies electric power of the battery 41 to the steering assist motor 42. In this example embodiment, the first power source harness 45 is wired inside the down tube 22.

The battery 41, the steering assist motor 42, the torque transmission 43, and the first power source harness 45 included in the steering assist device 40 are located farther forward than a midpoint M of a line segment connecting the front wheel axle 5a and the rear wheel axle 6a of the pedal-equipped bicycle 1, as viewing the pedal-equipped bicycle 1 in the left-right direction. Furthermore, the battery 41, the steering assist motor 42, the torque transmission 43, and the first power source harness 45 included in the steering assist device 40 are located farther forward than a rotation center P of the crank shaft 10, that is a rotation center of the left crank 8 and the right crank 9.

A weight of the battery 41, the steering assist motor 42, the torque transmission 43, and the first power source harness 45 applied to the front wheel axle 5a is determined by a ratio of a distance between a combined center of gravity of the battery 41, the steering assist motor 42, the torque transmission 43, and the first power source harness 45 and the rear wheel axle 6a to a distance between the front wheel axle 5a and the rear wheel axle 6a. The battery 41, the steering assist motor 42, the torque transmission 43, and the first power source harness 45 that are located farther forward than the midpoint M and the rotation center P are arranged such that the distance between the rear wheel axle 6a and the combined center of gravity is larger than a distance between the front wheel axle 5a and the combined center of gravity. Therefore, the weight of the battery 41, the steering assist motor 42, the torque transmission 43, and the first power source harness 45 is applied more to the front wheel axle 5a than to the rear wheel axle 6a (see white arrows F1 and F2 in FIG. 1).

The battery 41, the steering assist motor 42, the torque transmission 43, and the first power source harness 45 at least partially overlap the down tube 22, as viewing the pedal-equipped bicycle 1 in the up-down direction. The center of gravity of the battery 41, the steering assist motor 42, the torque transmission 43, and the first power source harness 45 is located near the virtual center plane C. Therefore, in the pedal-equipped bicycle 1, a deviation of a weight balance in the left-right direction caused by mounting the battery 41, the steering assist motor 42, the torque transmission 43, and the first power source harness 45 thereon is reduced or prevented.

In this example embodiment, the battery 41, the steering assist motor 42, the torque transmission 43, and the first power source harness 45 may overlap the virtual center plane C (see FIG. 2 and FIG. 5) extending through the centerline in the left-right direction, the centerline being the axis of the down tube 22, as viewing the pedal-equipped bicycle 1 in the up-down direction.

The steering assist device 40 configured as described above controls the steering assist motor 42 based on the torque signal detected by the torque sensor 44 via an unillustrated controller. The torque output by the steering assist motor 42 is transmitted to the steering collar 31 via the torque transmission 43.

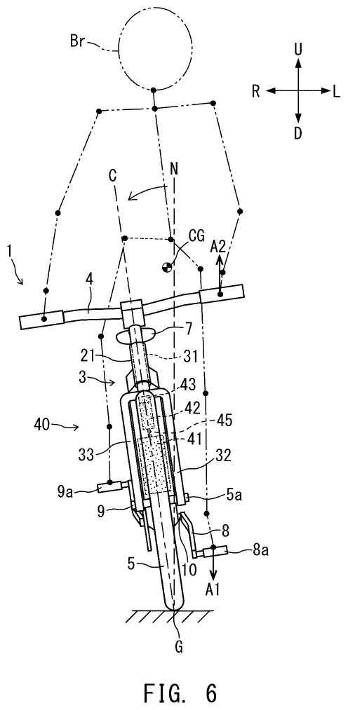

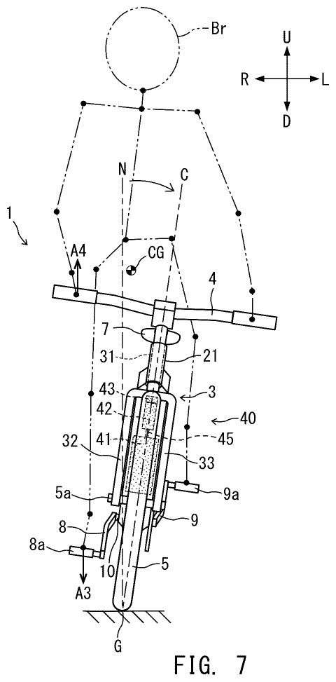

With reference to FIG. 5 to FIG. 7, a posture control by the rider Br when the rider Br pedals on the left pedal 8a and the right pedal 9a in the pedal-equipped bicycle 1 will be described. FIG. 5 is a front view of the pedal-equipped bicycle 1 in a state where the left pedal 8a and the right pedal 9a are not pedaled by the rider Br. FIG. 6 is a front view of pedal-equipped bicycle 1 in a state where the pedal-equipped bicycle 1 is caused to lean rightward when the left pedal 8a is pedaled by the rider Br. FIG. 7 is a front view of the pedal-equipped bicycle 1 in a state where the pedal-equipped bicycle 1 is caused to lean leftward when the right pedal 9a is pedaled by the rider Br. In the following description, it is assumed that the rider Br of the pedal-equipped bicycle 1 is riding on the pedal-equipped bicycle 1 in a state where the rider Br is standing up from the saddle 7.

As illustrated in FIG. 5, the virtual center plane C of the pedal-equipped bicycle when not leaning leftward or rightward is located at a neutral position N. At this time, a weight of the rider Br is applied equally to the left pedal 8a and the right pedal 9a of the pedal-equipped bicycle 1.

As illustrated in FIG. 6, when the rider Br of the pedal-equipped bicycle 1, for example, pedals on the left pedal 8a (see an arrow A1 in FIG. 6), the rider Br pulls a left portion of the handlebar 4 upward with a left hand (see an arrow A2 in FIG. 6) in order to receive an upward reaction force generated by pedaling the left pedal 8a. A downward force is applied to a body of the rider Br.

The pedal-equipped bicycle 1 is caused to lean farther rightward than the neutral position N with the grounding position G of each of the front wheel 5 and the rear wheel 6 with the road surface as the rotation center by pulling the left portion of the handlebar 4 upward in accordance with a magnitude of a pedaling force applied to the left pedal 8a by the rider Br. At this time, the rider Br shifts a center of gravity of the body leftward relative to the pedal-equipped bicycle 1 in order to maintain a travel direction of the pedal-equipped bicycle 1 the center of gravity of which has been shifted rightward. Thus, a position of a combined center of gravity CG between the center of gravity of the rider Br and the center of gravity of the pedal-equipped bicycle 1 is maintained near the neutral position N as viewed in the front-rear direction.

When the rider Br moves the left pedal 8a to a lowest position of the left pedal 8a, the rider Br stops pulling up the left portion of the handlebar 4. Next, the rider Br starts pedaling on the right pedal 9a and starts pulling a right portion of the handlebar 4 upward in order to receive an upward reaction force generated by pedaling on the right pedal 9a.

As illustrated in FIG. 7, the rider Br of the pedal-equipped bicycle 1 that was caused to lean farther rightward than the neutral position N pulls the right portion of the handlebar 4 upward with the right hand of the rider Br (see an arrow A4) in order to receive an upward reaction force generated by pedaling on the right pedal 9a (see an arrow A3). A downward force is applied to the body of the rider Br. Thus, the combined center of gravity is moved from a position where the pedal-equipped bicycle 1 was caused to lean farther rightward than the neutral position N with the grounding position G of each of the front wheel 5 and the rear wheel 6 as the rotation center toward the neutral position N.

The pedal-equipped bicycle 1 is caused to lean farther leftward than the neutral position N with the grounding position G of each of the front wheel 5 and the rear wheel 6 with the road surface as the rotation center by pulling the right portion of the handlebar 4 upward in accordance with the magnitude of the pedaling force applied to the right pedal 9a by the rider Br. At this time, the rider Br shifts the center of gravity of the body rightward relative to the pedal-equipped bicycle 1 in order to cause the pedal-equipped bicycle 1 the center of gravity of which has shifted leftward to travel straight ahead. Thus, the position of the combined center of gravity CG between the center of gravity of the rider Br and the center of gravity of the pedal-equipped bicycle 1 is maintained near the neutral position N as viewed in the front-rear direction.

In order to maintain the position of the combined center of gravity CG near the neutral position N, the rider Br of the pedal-equipped bicycle 1 causes the pedal-equipped bicycle 1 to lean rightward in accordance with pedaling the left pedal 8a and causes the pedal-equipped bicycle 1 to lean leftward in accordance with pedaling the right pedal 9a. When performing dancing that is an operation of pedaling on the left pedal 8a and the right pedal 9a in a state where the rider Br is standing from the saddle 7 to transmit a larger drive force to the rear wheel 6, the rider Br increases the lean of the pedal-equipped bicycle 1 in the left-right direction to a larger degree than the lean of the pedal-equipped bicycle 1 in the left-right direction in a state where the rider Br sits on the saddle 7. Thus, the pedal-equipped bicycle 1 travels straight ahead without turning by adjusting a direction and an amount of leaning in accordance with the weight of the pedal-equipped bicycle 1 and pedaling the left pedal 8a and the right pedal 9a.

The position of the center of gravity of the pedal-equipped bicycle 1 shifts from the virtual center plane C toward one side in the left-right direction as the battery 41, the steering assist motor 42, the torque transmission 43, and the first power source harness 45 are located farther apart from the virtual center plane C toward the one side in the left-right direction. Therefore, in the pedal-equipped bicycle 1, as a shift amount of the position of the center of gravity from the virtual center plane C toward one side in the left-right direction increases, a difference between an amount of leaning toward one side in the left-right direction and an amount of leaning toward the other side in the left-right direction when the pedal-equipped bicycle 1 is caused to lean in the left-right direction in accordance with pedaling the left pedal 8a and the right pedal 9a increases. That is, in the pedal-equipped bicycle 1, as the shift amount of the position of the center of gravity from the virtual center plane C toward one side in the left-right direction increases, dancing cannot be efficiently and properly performed.

A shift of the position of the center of gravity from the virtual center plane C in the pedal-equipped bicycle 1 is reduced or prevented by locating the battery 41, the steering assist motor 42, the torque transmission 43, and the first power source harness 45 so as to overlap the down tube 22. Therefore, in the pedal-equipped bicycle 1, the difference between the amount of leaning toward one side in the left-right direction and the amount of leaning toward the other side in the left-right direction in accordance with pedaling the left pedal 8a and the right pedal 9a is reduced or prevented. Thus, dancing can be efficiently and properly performed.

Furthermore, a distance between the battery 41, the steering assist motor 42, the torque transmission 43, and the first power source harness 45 and both legs of the rider Br is increased by locating the battery 41, the steering assist motor 42, the torque transmission 43, and the first power source harness 45 so as to overlap the down tube 22. Therefore, the freedom of movement of the legs of the rider Br at the left and right of the battery 41, the steering assist motor 42, the torque transmission 43, and the first power source harness 45 is increased.

Furthermore, in the pedal-equipped bicycle 1, since the weight of the battery 41, the steering assist motor 42, the torque transmission 43, and the first power source harness 45 is applied more to the front wheel axle 5a than to the rear wheel axle 6a, a friction force generated between the front wheel 5 and the road surface increases. Therefore, the torque of the steering assist motor 42 is efficiently transmitted to the road surface. As described above, by using the weight of the battery 41, the steering assist motor 42, the torque transmission 43, and the first power source harness 45, the control accuracy of the steering assist device 40 can be increased.

Furthermore, the battery 41, the steering assist motor 42, the torque transmission 43, and the first power source harness 45 are located farther rearward than the head tube 21 and farther forward than the midpoint M of the line segment connecting the front wheel axle 5a and the rear wheel axle 6a. Moreover, the combined center of gravity CG of the pedal-equipped bicycle 1 on which the rider Br rides is located farther rearward than the head tube 21 and farther forward than the midpoint M of the line segment connecting the front wheel axle 5a and the rear wheel axle 6a. Therefore, the battery 41, the steering assist motor 42, the torque transmission 43, and the first power source harness 45 are located near a yaw axis extending through the combined center of gravity CG of the pedal-equipped bicycle 1. Thus, an increase in the moment of inertia about the yaw axis caused by mounting the battery 41, the steering assist motor 42, the torque transmission 43, and the first power source harness 45 can be reduced or prevented. Operability of the pedal-equipped bicycle 1 during turning is affected by a magnitude of the moment of inertia about the yaw axis. In the steering assist device, the responsiveness is increased due to the reduction of the moment of inertia about the yaw axis, and a turning function of the steering assist device 40 can be easily exhibited.

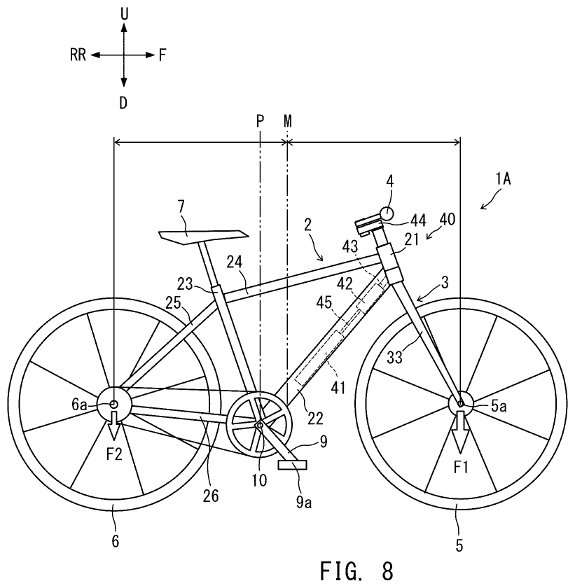

With reference to FIG. 8, a pedal-equipped bicycle 1A that is a variation of the pedal-equipped bicycle 1 according to an example embodiment of the present invention will be described. FIG. 8 is a side view of the pedal-equipped bicycle 1A according to a variation of the first example embodiment of the present invention. Note that, in the example embodiments described below, specific descriptions of points similar to those of the example embodiments already described will be omitted and description will be given with focus on different points.

As illustrated in FIG. 8, the pedal-equipped bicycle 1A includes the steering assist device 40.

The steering assist motor 42 of the steering assist device 40 is supported by the down tube 22. The steering assist motor 42 is housed in the down tube 22. In this case, the steering assist motor 42 is located so as to overlap the virtual center plane C (see FIG. 2) of the down tube 22 as viewed in the up-down direction.

Accordingly, the battery 41, the steering assist motor 42, the torque transmission 43, and the first power source harness 45 are housed in a hollow portion of the down tube 22 so that the virtual center plane C of the down tube 22 in the left-right direction and the rotation axis of the steering assist motor 42 are located so as to be close to each other. Therefore, the weight balance of the pedal-equipped bicycle 1A in the left-right direction is maintained substantially evenly. Thus, a deterioration in operability when the vehicle body is cause to lean leftward or rightward in accordance with pedaling the left pedal 8a and the right pedal 9a can be further reduced or prevented.

Example embodiments of the present invention have been described above, but the above-described example embodiments are merely examples for carrying out the present invention. Therefore, the present invention is not limited to the above-described example embodiments and the above-described example embodiments can be appropriately modified and implemented without departing from the gist of the present invention.

In the example embodiments described above, each of the pedal-equipped bicycles 1 and 1A includes the head tube 21, the down tube 22, the seat tube 23, and the top tube 24. However, the pedal-equipped bicycle may include the head tube, the down tube, and the seat tube.

In the first example embodiment described above, the battery 41, the steering assist motor 42, the torque transmission 43, and the first power source harness 45 are located so as to overlap the down tube 22, as viewing the pedal-equipped bicycle 1 in the up-down direction. However, the battery, the steering assist motor, the torque transmission, and the first power source harness may be located so as to at least partially overlap the down tube, as viewing the pedal-equipped bicycle in the up-down direction.

In the first example embodiment described above, the battery 41, the steering assist motor 42, the torque transmission 43, and the first power source harness 45 are located so as to overlap the down tube 22, as viewing the pedal-equipped bicycle 1 in the up-down direction. However, the battery 41, the steering assist motor 42, the torque transmission 43, and the first power source harness 45 may be also be located within the distance W3 between the right outer edge of the left pedal 8a and the left outer edge of the right pedal 9a, as viewing the pedal-equipped bicycle 1 in the up-down direction (see FIG. 4).

As illustrated in FIG. 4, the distance W3 is smaller than a distance between the left leg of the rider Br placed farther leftward than the right outer edge of the left pedal 8a and the right leg of the rider Br placed farther rightward than the left outer edge of the right pedal 9a. Therefore, interference of the battery 41, the steering assist motor 42, the torque transmission 43, and the first power source harness 45 located between the right outer edge of the left pedal 8a and the left outer edge of the right pedal 9a with the left leg of the rider Br placed on the left pedal 8a and the right leg of the rider Br placed on the right pedal 9a is reduced or prevented. Thus, the freedom of movement of the legs of the rider Br is increased in the pedal-equipped bicycle 1 including the steering assist device 40. Furthermore, the battery 41, the steering assist motor 42, the torque transmission 43, and the first power source harness 45 are located within the distance W3 with the virtual center plane C centered therebetween, as viewed in the up-down direction, and therefore, a deviation of the weight balance in the left-right direction is reduced or prevented. Thus, a deterioration in the operability during leaning in the left-right direction by the rider Br in accordance with pedaling on the left pedal 8a and the right pedal 9a can be reduced or prevented.

Alternatively, the battery 41, the steering assist motor 42, the torque transmission 43, and the first power source harness 45 may be located within the distance W2 between the both ends of the crank shaft 10, as viewing the pedal-equipped bicycle 1 in the up-down direction (see FIG. 4).

As illustrated in FIG. 4, the distance W2 is smaller than a distance between the left leg of the rider Br placed farther leftward than the right outer edge of the left pedal 8a and the right leg of the rider Br placed farther rightward than the left outer edge of the right pedal 9a. Accordingly, the battery 41, the steering assist motor 42, the torque transmission 43, and the first power source harness 45 that are located between the right outer edge of the left pedal 8a and the left outer edge of the right pedal 9a are spaced apart from the left leg of the rider Br placed farther leftward than the right outer edge of the left pedal 8a and the right leg of the rider Br placed farther rightward than the left outer edge of the right pedal 9a toward the down tube 22. Therefore, in the pedal-equipped bicycle 1 including the steering assist device 40, the degree of freedom of movement of the legs of the rider Br is increased. Furthermore, the battery 41, the steering assist motor 42, the torque transmission 43, and the first power source harness 45 are located within the distance W2 with the virtual center plane C centered between, as viewed in the up-down direction, and therefore, a deviation of the weight balance in the left-right direction is reduced or prevented. Thus, a deterioration in operability during leaning in the left-right direction by the rider Br in accordance with pedaling on the left pedal 8a and the right pedal 9a can be reduced or prevented.

Alternatively, the battery 41, the steering assist motor 42, the torque transmission 43, and the first power source harness 45 may be located between the left outer edge and right outer edge of the down tube 22 when viewing the pedal-equipped bicycle 1 in the up-down direction of (see FIG. 4).

As illustrated in FIG. 4, the battery 41, the steering assist motor 42, the torque transmission 43, and the first power source harness 45 that are located within the width W1 of the down tube 22 with the virtual center plane C centered therebetween are close to the axis of the down tube 22 within the width of the down tube 22 in the left-right direction. Therefore, in the pedal-equipped bicycle 1 including the steering assist device 40, the freedom of movement of the legs of the rider Br can be increased. Furthermore, a deviation of the weight balance of the pedal-equipped bicycle 1 in the left-right direction caused by locating the battery 41, the steering assist motor 42, the torque transmission 43, and the first power source harness 45 is reduced or prevented. Thus, a deterioration in operability during leaning in the left-right direction by the rider Br in accordance with pedaling the left pedal 8a and the right pedal 9a can be reduced or prevented.

Alternatively, the battery 41, the steering assist motor 42, the torque transmission 43, and the first power source harness 45 may be located within the distance W4 between the left outer edge of the left fork portion 32 and the right outer edge of the right fork portion 33 with the virtual center plane C centered therebetween, as viewing the pedal-equipped bicycle 1 in the up-down direction (see FIG. 4).

As illustrated in FIG. 4, the distance W4 is larger than the distance W2 between the both ends of the crank shaft 10. Accordingly, the battery 41, the steering assist motor 42, the torque transmission 43, and the first power source harness 45 are not located more outward in the left-right direction than the front fork 3, as viewed in the front-rear direction. Therefore, in the pedal-equipped bicycle 1, while reducing or preventing contact of the battery 41, the steering assist motor 42, the torque transmission 43, and the first power source harness 45 with an obstacle or the like approaching from front of the pedal-equipped bicycle 1, a deviation of the weight balance of the pedal-equipped bicycle in the left-right direction caused by the battery 41, the steering assist motor 42, the torque transmission 43, and the first power source harness 45 is reduced or prevented. Thus, a deterioration in operability during leaning in the left-right direction by the rider Br in accordance with pedaling the left pedal 8a and the right pedal 9a can be reduced or prevented.

In the first example embodiment described above, the battery 41, the steering assist motor 42, the torque transmission 43, and the first power source harness 45 are located inside the down tube 22. However, the battery, the steering assist motor, the torque transmission, and the first power source harness may be at least partially located outside the downtube and so as to at least partially overlap the down tube, as viewing the pedal-equipped bicycle in the up-down direction.

In the first example embodiment described above, the battery 41, the steering assist motor 42, the torque transmission 43, and the first power source harness 45 overlap the axis of the down tube 22, as viewing the pedal-equipped bicycle 1 in the up-down direction. However, the battery, the steering assist motor, the torque transmission, and the first power source harness may at least partially overlap the down tube in a state where the battery, the steering assist motor, the torque transmission, and the first power source harness do not overlap the axis of the down tube, as viewing the pedal-equipped bicycle in the up-down direction.

In the first example embodiment described above, the battery 41, the steering assist motor 42, the torque transmission 43, and the first power source harness 45 are supported by the downtube 22. However, the battery, the steering assist motor, the torque transmission, and the first power source harness may at least partially overlap the down tube in a state where the battery, the steering assist motor, the torque transmission, and the first power source harness are supported by at least one of the head tube, the top tube, or the seat tube, as viewing the pedal-equipped bicycle in the up-down direction.

In the example embodiments described above, the steering assist motor 42 is located on the lower surface of the down tube 22. In the variation of the example embodiments described above, the steering assist motor 42 is located inside the down tube 22. However, the steering assist motor may be located on an upper surface of the down tube.

In the example embodiments described above, the torque transmission 43 is located on a bottom surface of the down tube 22 or inside the down tube 22. However, the torque transmission may be located on a top surface of the down tube or the top tube. Furthermore, the torque transmission may be housed inside the head tube and may be located outside the vehicle body frame.

In the example embodiments described above, the steering assist motor 42 is located closer to the head tube 21 than the battery 41. However, the steering assist motor may be located farther from the head tube than the battery and may be located at a position at the same distance from the head tube as the battery. Furthermore, one of the steering assist motor or the battery may be located outside the down tube and may be located inside the top tube.

In each of the example embodiments described above, the steering assist device 40 includes the steering assist motor 42 as an actuator. However, the actuator of the steering assist device may be any electric actuator, such as an electric cylinder or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A pedal-equipped bicycle comprising:
a vehicle body frame including a head tube, and a down tube including a front end connected to a rear edge of the head tube and extending obliquely downward such that a rear end of the down tube is lower than the front end;
a front wheel supported by a front fork including a steering column rotatably supported by the head tube;
a rear wheel supported by the vehicle body frame;
a left crank and a right crank supported by the vehicle body frame; and
a steering assist device including a steering assist motor, a battery to supply electric power to the steering assist motor, a first power source harness to electrically connect the steering assist motor and the battery, a controller configured or programmed to control the steering assist motor, and a torque transmission to transmit a torque of the steering assist motor to the steering column; wherein
the steering assist device includes a torque sensor to detect a torque applied to the steering column;
the steering assist motor, the battery, the first power source harness, and the torque transmission (1) are located farther forward than a midpoint of a line segment that connects axles of the front wheel and the rear wheel and farther forward than a rotation center of the left crank and the right crank as viewed in a left-right direction of the pedal-equipped bicycle, and (2) at least partially overlap the down tube as viewed in an up-down direction of the pedal-equipped bicycle; and
the controller is configured or programmed to control the steering assist motor based on a torque signal detected by the torque sensor.

2. The pedal-equipped bicycle according to claim 1, wherein
the steering assist motor, the battery, the first power source harness, and the torque transmission are located between a right outer edge of a left pedal supported by the left crank and a left outer edge of a right pedal supported by the right crank as viewed in the up-down direction.

3. The pedal-equipped bicycle according to claim 1, wherein
the steering assist motor, the battery, the first power source harness, and the torque transmission are located between both ends of a crank shaft that connects the left crank and the right crank as viewed in the up-down direction.

4. The pedal-equipped bicycle according to claim 1, wherein
the steering assist motor, the battery, the first power source harness, and the torque transmission are located between a left outer edge and a right outer edge of the down tube as viewed in the up-down direction.

5. The pedal-equipped bicycle according to claim 1, wherein
the steering assist motor, the battery, the first power source harness, and the torque transmission are located between a left outer edge of a left fork of the front fork and a right outer edge of a right fork of the front fork as viewed in the up-down direction.
